(19) United States
(12) Patent Application Publication
(10) Pub. No.: US 2015/0327052 A1
(43) Pub. Date: Nov. 12, 2015

(54) Techniques for Managing Network Access

(71) Applicant: Benu Networks, Inc., Billerica, MA (US)

(72) Inventor: Rajat GHAI, Sandwich, MA (US)

(21) Appl. No.: 14/707,695

(22) Filed: May 8, 2015

Related U.S. Application Data
(60) Provisional application No. 61/990,298, filed on May 8, 2014.

(51) Int. Cl. H04W 8/18; H04W 12/06

(52) U.S. Cl. CPC H04W 8/18; H04W 12/06; H04W 12/08

(57) ABSTRACT

Computer-implemented systems, methods, and computer-readable media are provided for managing access of a wireless device to a network based on one or more policies. In accordance with some embodiments, a request for authorization to associate a wireless device with a network is received. A policy associated with the network is retrieved from a storage device in response to the request. A determination is then made as to whether information included in the request satisfies a condition in the policy. If the information satisfies the condition, a response is transmitted granting authorization to associate the wireless device with the network. If the information does not satisfy the condition, a response is transmitted denying authorization to associate the wireless device with the network.

### RELATED APPLICATIONS

This application claims priority to U.S. Provisional Patent Application No. 61/990,298, filed on May 8, 2014, the disclosure of which is expressly incorporated herein by reference to its entirety.

### FIELD

The subject matter disclosed in this application generally relates to computerized techniques for managing network access, and more specifically, to centrally controlling access to network connections. By way of example, and without limitation, the present disclosure relates to computerized techniques for receiving a request for access to a wireless network, and for granting or denying access to the wireless network based on information in the request.

### BACKGROUND

Less than a decade ago most people carried only one network-enabled device, such as a Wi-Fi enabled laptop. Since then, what is often referred to as the Wi-Fi revolution has taken the world by storm. According to Wi-Fi Alliance, there were approximately 1.1 Billion Wi-Fi enabled devices shipped in 2012 alone. With the proliferation of Wi-Fi enabled smartphones, tablets, gaming consoles, and embedded household appliances like TVs, an average household has more than five Wi-Fi enabled devices at any given time. Wi-Fi devices support a number of vertical applications like health, fitness, smart energy and Internet of things (IoT). These and other applications are anticipated to drive the total amount of Wi-Fi shipments per year to double to 2.2 Billion in 2016. One universal Wi-Fi spectrum and the rapid standardization and adoption cycle of Wi-Fi technologies, such as 802.11a/b/g/n and soon 802.11u and 802.11ac, has made Wi-Fi the broadband wireless access of choice.

In parallel, cloud computing and associated cloud technologies are creating an information technology (IT) revolution of their own. The adoption of cloud technology was possible due to cheap long haul transmission capacity (often referred to as “fat pipes”), and the low cost of compute cycles and storage. Leveraging this trend, Wi-Fi and cloud technologies combined are expected to usher in a new era of ubiquitous networking and service availability.

The first generation Wi-Fi access points (APs) were standalone APs, such as those provided by Linksys, Netgear, etc. Such APs are often referred to as autonomous, independent, or fat APs. Such APs typically have a complete Internet protocol (IP) router function that includes a local Dynamic Host Configuration Protocol (DHCP) server, a basic network address translation (NAT) port, support for popular port triggering protocols (e.g., such as Universal Plug and Play (UPnP) protocols, a NAT port mapping protocol (PMP)), and a domain name system (DNS) server. Some of these Wi-Fi APs include basic access control functions (ACL) like media access control (MAC) filtering and time of the day-based Internet access restrictions.

However, such first generation standalone APs must typically be configured individually. Therefore, to deploy multiple standalone APs (which is becoming the norm), a network administrator must log into and configure each Wi-Fi AP independently, making configuration changes a tedious and error-prone process. In addition, standalone APs make it difficult for the user to monitor the wireless network in a centralized manner, because obtaining statistics such as aggregated bandwidth statistics, usage data, and/or status information across all of the APs in the network must be done manually. Further, to configure the AP the network administrator often needs to be familiar with IP networking and configuration options for the AP that is made available through a graphical user interface (GUI) provided by an embedded web server in the AP. Additionally, broadband service providers often cannot provide any value added device management services, because the Wi-Fi home AP NATs all the IP traffic and hides all device visibility.

Campuses and large enterprise applications often require the management of multiple APs (e.g., 10s to a few 100 access points). Standalone APs are fast becoming impossible to manage in any scale, so companies are beginning to move to a hierarchical architecture for centralized monitoring and configuration of APs. Some such architectures include a Wireless Access Controller designed to scale to a few hundred APs. The interface between the AP and controller may be proprietary and loosely based on the Control and Provisioning of Wireless Access Points (CAPWAP) protocol (e.g., specified in RFC 5415). The Wi-Fi access and IP router functions of the standalone AP may be split between the dependent AP and the Wireless Access Controller. Since the interface between the controller and AP may be vendor specific, the split functionality may vary between vendors. Other architectures can also include an AP architecture where certain functions of the Wi-Fi MAC is split between the APs and the controller (often referred to as a “split MAC architecture”). This architecture can allow the controller to perform centralized radio frequency (RF) management of APs for interference mitigation and coordination.

However, such controllers operate at Layer 3 (or higher) and provide centralized management and configuration of the IP control plane, the traffic/forwarding plane, and RF management. This configuration (e.g., typically implemented on 1 rack-unit (1 RU) or 2 rack-unit (2RU) servers) can severely limit the scalability of such a solution to a few hundred APs, which is not suitable for the massive scale of outdoor and residential applications. For example, tens of thousands of Wireless Access Controllers would need to be deployed to support millions of concurrently active devices. Such a solution would be nearly impossible to manage and would be cost prohibitive since Wireless Access Controllers are very expensive. Further, the Wireless Access Controller is a single point of failure, so if a wireless local area network (WLAN) controller fails then all of the APs connected to that controller will also fail. Dual-redundant controllers, while technically possible, are often cost prohibitive. And like first generation APs, device management and device centric value added services can't be provided because the controller hides the topology and the devices that the controller manages.

### SUMMARY

Given the proliferation of network-enabled devices (e.g., Wi-Fi devices), it would be advantageous for service providers to be able to provide managed network services to residential and business customers. In many cases, home networks may now have more Wi-Fi devices than early enterprise networks. Managed Wi-Fi may be attractive to residential users, because it can offer continuous Wi-Fi access to their smartphones and tablets (post PC devices) across multiple remotely-located radio nodes, as well as device centric value-added services. Service provider managed Wi-Fi solutions are also attractive for businesses to allow businesses to lower their IT costs by not needing to procure and deploy their own standalone or controller-based Wi-Fi solutions.

Embodiments of the present disclosure relate to computerized techniques for managing network access. In addition, embodiments of the present disclosure relate to receiving a request for access to a wireless network, and for granting or denying access to the wireless network based on information in the request.

In accordance with certain embodiments of the present disclosure, computerized systems and methods are provided that receive a request for authorization to associate a wireless device with a network, and retrieve a policy associated with the network from a storage device. Once the policy has been retrieved, the computerized systems and methods may cause a determination to be made that information included in the request either satisfies or fails to satisfy a condition in the policy. The computerized systems and methods may then cause a response to be transmitted either granting or denying authorization to associate the wireless device with the network based at least in part on the determination.

In accordance with some embodiments, there is provided a computer-implemented method for managing access of a wireless device to a network based on one or more policies. The method comprises receiving, by a computing device including a memory and a processor configured to execute instructions stored in the memory, a request for authorization from an access point to associate a wireless device with a network. The method also comprises retrieving, by the computing device, a policy associated with the network from a storage device in response to the request. The method further comprises determining, by the computing device, that information included in the request fails to satisfy a condition in the policy. The method still further comprises transmitting, by the computing device, a response to the access point denying authorization to associate the wireless device with the network based at least in part on the determination that the information failed to satisfy the condition.

In accordance with certain aspects of the present disclosure, the request is a first request, the network is a first network, the policy is a first policy, the information is first information, the condition is a first condition, and the response is a first response, and the method further comprises receiving, by the computing device, a second request for authorization to associate the wireless device with a second network. The method also comprises retrieving, by the computing device, a second policy associated with the second network from the storage device in response to the second request. The method further comprises determining, by the computing device, that second information included in the second request satisfies a second condition in the second policy. The method still further comprises transmitting, by the computing device, a second response granting authorization to associate the wireless device with the second network based at least in part on the determination that the second information satisfies the second condition.

In accordance with additional aspects of the disclosure, the condition of the policy restricts authorization to the network based on at least one of the following: a type of the wireless device, a location of the wireless device, an application of the wireless device that caused the request to be generated, a time at which the request was generated, a type of subscriber associated with the wireless device, a level of congestion on the network, and a number of devices associated with a user of the wireless device that are associated with the wireless network.

In accordance with further aspects of the disclosure, the information conveys a type of the wireless device, and the determining comprises identifying that the type of the wireless device is not a type that satisfies the condition of the policy.

In accordance with still further aspects of the disclosure, the request is generated as a result of a selection of a service set identifier (SSID) of the network at the wireless device.

In accordance with additional aspects of the disclosure, the computing device is a gateway, and the gateway includes the storage device.

In accordance with further aspects of the disclosure, the request is a Remote Authentication Dial In User Service (RADIUS) access request message, and the response is a RADIUS response message.

In accordance with still further aspects of the disclosure, the policy was received from an authentication, authorization, and accounting (AAA) server.

In accordance with additional aspects of the disclosure, the first network is a public network, and the second network is a private network.

In accordance with further aspects of the disclosure, at least one of the first network and the second network is a Wi-Fi network.

Furthermore, in accordance with some embodiments, there is provided a computer-implemented system for managing access of a wireless device to a network based on one or more policies. The system comprises one or more memory devices that store instructions, and one or more processors that execute the instructions. The one or more processors execute the instructions to receive a request for authorization from an access point to associate a wireless device with a network. The one or more processors also execute the instructions to retrieve a policy associated with the network from a storage device in response to the request. The one or more processors further execute the instructions to determine that information included in the request fails to satisfy a condition in the policy. The one or more processors still further execute the instructions to cause a response to be transmitted to the access point denying authorization to associate the wireless device with the network based at least in part on the determination that the information failed to satisfy the condition.

In accordance with certain aspects of the present disclosure, the request is a first request, the network is a first network, the policy is a first policy, the information is first information, the condition is a first condition, and the response is a first response, and the one or more processors further execute the instructions to receive a second request for authorization to associate the wireless device with a second network. The one or processors also execute the instructions to retrieve a second policy associated with the second network from the storage device in response to the second request. The one or more processors further execute the instructions to determine that second information included in the second request satisfies a second condition in the second policy. The one or more processors still further execute the instructions to cause a second response to be transmitted granting authorization to associate the wireless device with the second network based at least in part on the determination that the second information satisfies the second condition.

In accordance with additional aspects of the disclosure, the condition of the policy restricts authorization to the network based on at least one of the following: a type of the wireless device, a location of the wireless device, an application of the wireless device that caused the request to be generated, a time at which the request was generated, a type of subscriber associated with the wireless device, a level of congestion on the network, and a number of devices associated with a user of the wireless device that are associated with the wireless network.

In accordance with further aspects of the disclosure, the information conveys a type of the wireless device, and the one or more processors further execute the instructions to identify that the type of the wireless device is not a type that satisfies the condition of the policy.

In accordance with still further aspects of the disclosure, the request is generated as a result of a selection of a service set identifier (SSID) of the network at the wireless device.

In accordance with further aspects of the disclosure, the request is a Remote Authentication Dial In User Service (RADIUS) access request message, and the response is a RADIUS response message.

In accordance with still further aspects of the disclosure, the policy was received from an authentication, authorization, and accounting (AAA) server.

In accordance with additional aspects of the disclosure, the first network is a public network, and the second network is a private network.

In accordance with further aspects of the disclosure, at least one of the first network and the second network is a Wi-Fi network.

Additionally, in accordance with some embodiments, there is provided a non-transitory computer-readable medium that stores instructions. The instructions, when executed by one or more processors, cause the one or more processors to perform a method for managing access of a wireless device to a network based on one or more policies. The method comprises receiving a request for authorization from an access point to associate a wireless device with a network. The method also comprises retrieving a policy associated with the network from the storage device in response to the request. The method further comprises determining that information included in the request fails to satisfy a condition of the policy. The method still further comprises causing a response to be transmitted to the access point denying authorization to associate the wireless device with the network in response to the determination that the information failed to satisfy the condition.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute part of the specification, and together with the description, illustrate and serve to explain the principles of various example embodiments.

FIG. 1 illustrates a block diagram of an example system for centrally managed Wi-Fi, according to some embodiments.

FIG. 2 illustrates an example of a Wi-Fi device printing to a local Wi-Fi printer using centrally managed Wi-Fi, according to some embodiments.

FIG. 3 illustrates an example of a Wi-Fi device moving to a different radio node using centrally managed Wi-Fi, according to some embodiments.

FIG. 4 illustrates an example of a Wi-Fi device printing to a Wi-Fi printer supported by a different radio node using centrally managed Wi-Fi, according to some embodiments.

FIG. 5 illustrates an example of parental control of a Wi-Fi device using centrally managed Wi-Fi, according to some embodiments.

FIG. 6 illustrates a block diagram of another example computing environment, in accordance with some embodiments.

FIG. 7 illustrates a diagram of example messages transmitted over time in managing access of a wireless device to a network, in accordance with some embodiments.

FIG. 8 illustrates a flowchart of an example method for managing access of a wireless device to a network, in accordance with some embodiments.

FIG. 9 illustrates a diagram of an example computer system, in accordance with some embodiments.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

Embodiments of the present disclosure relate to computerized systems and methods for managing network access. Embodiments of the present disclosure include systems and methods that may receive a request for authorization to associate a device with a network. A policy associated with the network may then be retrieved from a storage device. For example, the storage device may store policies that include one or more conditions for granting or denying access to certain networks. A determination may then be made as to whether information included in the request satisfies a condition of the policy. If the information satisfies the condition, a response may be transmitted granting authorization to associate the device with the network. If the information does not satisfy the condition, a response may be transmitted denying authorization to associate the device with the network.

Over the years, people have become more and more reliant on electronic devices and network connections to access content. People often bring their electronic devices to different locations, and attempt to connect to different wireless networks at these locations. However, often the only networks that are available are private networks, which require a particular subscriber's authentication information, such as a password, to access. Some service providers are attempting to address this problem by providing Wi-Fi access points in subscriber homes that double as both a private access point and public access point. For example, the access point may provide a private Wi-Fi network, which is intended for use by the subscriber or individuals authorized to use the private network by the subscriber. Access to such a private network may require authentication information, such as the subscriber's password or key.

The access point may also provide a public Wi-Fi network, which is intended for use by a larger community of users. For example, the public Wi-Fi network may not require authentication information to be entered, thereby allowing any individual with a Wi-Fi device to connect to the network. Alternatively, the public Wi-Fi network may require authentication, while being available to a larger group of individuals. For example, a service provider may allow any subscriber of its service to access a public Wi-Fi network through a subscriber's access point by entering his/her service provider username and password.

There are advantages to providing access to both private and public Wi-Fi networks through a subscriber's access point. For example, providing a Wi-Fi access point with such dual functionality may allow a service provider to provide a large, distributed Wi-Fi network to its subscribers. Providing such service may make a particular service provider more popular than others, and help them attract and retain customers. However, a wireless device may not be able to distinguish to which Wi-Fi network it should connect. For example, a wireless device may select a service set identifier (SSID) associated with a public network, even when the wireless device is in the user's home. Moreover, a subscriber may not be sure which network is the private network, and may select an SSID of a public network for wireless connection. Selecting to connect to the public network may be disadvantageous in these situations, as the public network may be less secure and/or provide a lower quality of service (e.g., slower upload and/or download speeds). Moreover, because the public network may provide Wi-Fi access to many individuals, adding devices that already have the ability to access a private network may unnecessarily add to congestion on the public network. A connection to the public network may also prevent a user from carrying out certain functions associated with his/her private network, such as access home network devices, local printers, etc. When such functionality does not work, users who are not tech savvy are likely to call service provider call centers seeking assistance, and it can be expensive for service providers to service all these calls.

Embodiments of the present disclosure can address the challenges associated with Wi-Fi network selection. For example, embodiments of the present disclosure provide computerized systems and methods that may manage access of a device to a network. The computerized systems and methods disclosed herein may receive a request for authorization to associate a wireless device with a network. Such a request may be received, for example, by a wireless access gateway (WAG) from an AP, such as a home gateway (HGW). A policy associated with the network may then be retrieved from a storage device. For example, the WAG may store a number of policies associated with particular networks, or with particular types of networks. The policies may include conditions upon which devices may be granted or denied access to a particular network. The computerized systems and methods disclosed herein may then determine whether information included in the request satisfies a condition of the policy. If the information satisfies the condition, the WAG may transmit a response to the AP granting authorization to associate the wireless device with the network. If the information does not satisfy the condition, the WAG may transmit a response to the AP denying authorization to associate the wireless device with the network. Thus, based on policies stored at the WAG, the WAG may control which networks devices are able to access, thus allowing the WAG to centrally manage the networks to ensure that wireless devices are making the best use of available networks.

The computer-implemented methods disclosed herein may be executed, for example, by one or more computer processors that receive instructions from one or more non-transitory computer-readable media. Similarly, systems consistent with the present disclosure may include one or more computer processors and one or more memories, and the one or more memories may be non-transitory computer-readable media.

As used herein, a non-transitory computer-readable medium refers to any type of physical memory on which information or data readable by a computer processor may be stored. Examples include random access memory (RAM), read-only memory (ROM), volatile memory, nonvolatile memory, hard drives, compact disc ROMs (CD ROMs), digital versatile discs (DVDs), flash drives, magnetic strip storage, semiconductor storage, optical disc storage, magneto-optical disc storage, and/or any other known physical storage medium. Singular terms, such as “memory” and “computer-readable storage medium,” may additionally refer to multiple structures, such as a plurality of memories and/or computer-readable storage mediums.

As used herein, a “memory” may comprise any type of computer-readable storage medium unless otherwise specified. A computer-readable storage medium may store instructions for execution by one or more processors, including instructions for causing the one or more processors to perform steps or stages consistent with embodiments disclosed herein. Additionally, one or more computer-readable storage mediums may be utilized in a computer-implemented method.

As used herein, the indefinite articles “a” and “an” mean “one or more” in open-ended claims containing the transitional phrase “comprising,” “including,” and/or “having.”

Software-defined networking (SDN) is an approach to computer networking that allows network administrators to manage network services through abstraction of lower level functionality. Abstraction is done by decoupling the system that makes decisions about where traffic is sent (e.g., referred to as the “control plane”) from the underlying systems that forward traffic to the selected destination (e.g., referred to as the “data plane”). SDN principles of separating the control plane and data plane can leverage cloud computing technology to realize a large scale cloud networking infrastructure.

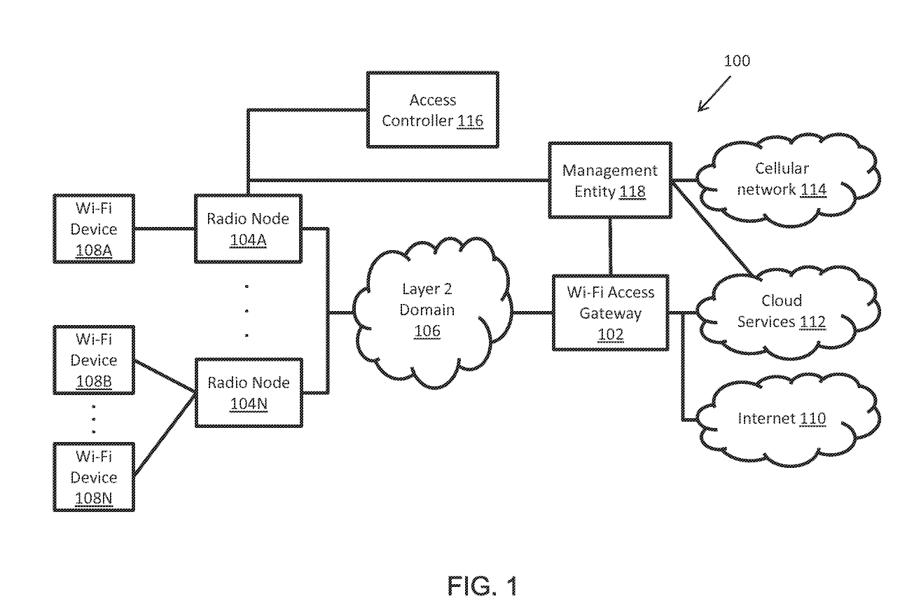

SDN principles can be applied to provide a Wi-Fi architecture that separates the data and control planes to provide a Layer 2-based data framework for centrally managed Wi-Fi. FIG. 1 illustrates a block diagram of a system 100 for centrally managed Wi-Fi, according to some embodiments. In some embodiments the system 100 can be a wide area switched Layer 2 Wi-Fi domain that extends to millions of Wi-Fi devices. As shown in FIG. 1, the system 100 includes a Wi-Fi access gateway 102 (also referred to herein as WAG 102) in communication with radio nodes 104A through 104N (collectively referred to herein as radio node 104) via a Layer 2 domain 106. Each radio node 104 can be in communication with a set of Wi-Fi devices. As shown in system 100, radio node 104A is in communication with Wi-Fi device 108A and radio node 104N is in communication with Wi-Fi device 108B through Wi-Fi device 108N (collectively referred to herein as Wi-Fi device 108). Wi-Fi access gateway 102 is connected to the Internet 110 and cloud services 112. Management entity 118 is connected to the WAG 102, the operations support system/business support system (OSS/BSS) 114, the cloud services 112, and the radio nodes 104. The Wi-Fi Access Gateway 102 is also in communication with a access controller 116 that is in communication with the radio nodes 104.

As shown in FIG. 1, the system 100 configuration separates the control plane (e.g., a wireless local area network/radio resource management (WLAN/RRM) control plane) and the user device traffic plane. The control plane is provided by the access controller 116 to the radio nodes 104. In some embodiments, the control plane is tunneled using control and provisioning of wireless access points/lightweight access point protocol (CAPWAP/LWAPP) towards the access controller 116 (e.g., a WLAN Access Controller). The data plane is provided by the WAG 102 via the Layer 2 domain 106 to the radio nodes 104. In some embodiments, the device user plane traffic is tunneled using, e.g., soft generic routing encapsulation (SoftGRE) and/or any other standards-based Layer 2 tunneling protocol, to the WAG 102.

Wi-Fi access gateway 102 can include a processor (not shown) configured to implement the functionality described herein using computer executable instructions stored in temporary and/or permanent non-transitory memory. The memory can be flash memory, a magnetic disk drive, an optical drive, a programmable read-only memory (PROM), a read-only memory (ROM), or any other memory or combination of memories. The processor can be a general purpose processor and/or can also be implemented using an application specific integrated circuit (ASIC), programmable logic array (PLA), field programmable gate array (FPGA), and/or any other integrated circuit. The Wi-Fi access gateway 102 can include a database that may also be flash memory, a magnetic disk drive, an optical drive, a programmable read-only memory (PROM), a read-only memory (ROM), or any other memory or combination of memories. The Wi-Fi access gateway 102 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs.

Referring further to the WAG 102, the WAG 102 can provide a data plane with radio nodes 104. In some embodiments, the WAG 102 is a highly scalable platform that implements data/traffic plane aggregation of switched Ethernet virtual domains over a wide geographical area, allowing the WAG 102 to serve millions of devices. The WAG 102 can include connections to each of the radio nodes 104, such as a GRE tunnel that encapsulates the Layer 2 traffic from the Wi-Fi devices 108, served by a corresponding radio node 104.

In some embodiments, the WAG 102 provides high performance point-to-point switched Layer 2 domain. In a classical open systems interconnection (OSI) layered computer networking model, network mobility (e.g., for session persistence) is often quicker at lower layers, e.g. Ethernet (layer 2) as opposed to networking layer (L3) or application layer (L7). However, the lower layers are often more messaging intensive than higher layers. The techniques described herein provide for a wide area Layer 2 network, such that high-performance equipment is able to participate with exponentially large number of transactions per second (TPS) while still providing seamless mobility at the MAC layer (Ethernet Layer). For example, flat Layer 2 domains (e.g., also called broadcast domains) are usually geographically small by design. To create a wide area Layer 2 network, virtual networks can be created by creating Layer 2 tunnels such that two devices think that they can see each other directly, yet they are located remotely from each other. These tunnels (e.g., also called overlays) are point to point over a routed IP network. Under some embodiments, such tunnels are also called pseudo-wires.

In some embodiments, the WAG 102 provides a high performance IP data/forwarding plane that can analyze, shape, forward, etc. IP traffic from end Wi-Fi devices. As alluded to above, Layer 2 domains are often very messaging intensive, which is why they are often limited to a small geographical area serving a small set of devices on a Ethernet segment. However, by creating large wide area Layer 2 networks, the techniques described herein can support processing a tremendous number (e.g., hundreds of millions) of packets/frames per second by using wide area Layer 2 networks. Dense aggregation at the WAG 102 with a high performance forwarding plane (e.g., packet processing) allows service providers to, for example, inspect, and inject cloud-based bespoke data services (e.g. content filtering and parental control).

Referring to the Layer 2 domain 106, the WAG 102 and the radio nodes 104 are connected via the Layer 2 domain 106. For example, the Layer 2 domain 106 can be provided using Layer 2 switching that uses the media access control (MAC address) from a device to determine where to forward frames. The Layer 2 domain 106 can implement the switching via hardware, such as using application-specific integrated circuits to build and maintain the filter tables. Additionally, for example, unlike other layers the Layer 2 domain 106 does not need to modify the data packet. Thus the Layer 2 domain 106 can be advantageous because it can provide high speed transmissions with low latency. As described above, the Layer 2 domain 106 provides Layer 2 point-to-point tunnels between the radio nodes 104 and the WAG 102. For example, an IP point-to-point tunnel can be established so that Layer 2 packets can be wrapped in IP packets and transmitted freely between the radio nodes 104 and the WAG 102.

The WAG 102 can provide IP services and/or muting functions, such as dynamic host configuration protocol (DHCP), universal plug and play (UPnP), network address translation port mapping protocol (NAT-PMP), access control list (ACL), address resolution protocol (ARP), and/or other services and functions. The WAG 102 can provide dual stack IP to offer service to both IPv4 and IPv6. As shown in FIG. 1, the WAG 102 can provide backbone connectivity to multiple IP cloud services 112 and/or the Internet 110. The WAG 102 can also provide security and session isolation among connections with each of the radio nodes 104.

Referring to the radio node 104, as described above with respect to the WAG 102, the radio node 104 can include a processor configured to implement the functionality described herein using computer executable instructions stored in temporary and/or permanent non-transitory memory. As explained further herein, due to the system 100 structure the radio node 104 can be less complex than existing nodes, and can therefore be a lower-cost device. For example, access points typically have complete IP routing capability (e.g., in addition of providing Radio function, the access points also provide an edge router function and offer services like DHCP Service, IP NAT service, etc.). These and other features often make access points complex and rigid. The radio node 104, on the other hand, in some embodiments is comparable to the access point only from a radio-function standpoint. For example, in some embodiments the radio node 104 does not have the IP router function and associated IP services. Rather, such radio nodes 104 merely bridge the Internet traffic to the core IP services Node using point-to-point Layer 2 overlay (e.g., tunnels). This makes the Radio Nodes simpler and IP services agnostic.

The radio node 104 can be configured to implement a Layer 2 bridge that terminates Wi-Fi MAC (e.g., 802.11x RF) towards a device. And as described herein the radio node 104 can encapsulate the Layer 2 traffic from a device for transmission to the WAG 102 (e.g., via GRE tunnel encapsulation of Layer 2 traffic from a device). The radio node 104 can implement an open programmable Layer 2 forwarding information base (FIB) that can be controlled by, e.g., a flow controller in the management entity 118 or a flow controller in a service provider's private cloud. The FIB is the Layer 2 forwarding table. The radio nodes 104 have the FIB so that it can keep any local Layer 2 traffic local, while the radio nodes 104 tunnel the rest of the traffic via Layer 2 up to the WAG 102. FIBs in the radio nodes 104 can be dynamically controlled or programmed from the network using a control protocol. This can allow the core network to control the Layer 2 forwarding behavior of the radio node 104 in a programmatic fashion.

A service set includes all the devices associated with a consumer or enterprise IEEE 802.11 wireless local area network. A basic service set (BSS) is often used to refer to a single access point together with all associated stations. An extended service set (ESS) is a set of two or more interconnected wireless BSSs that share similar features (e.g., network name, security credentials, etc.). Each BSS or ESS is identified by a service set identifier (SSID), which is usually a human-readable string often referred to as the “network name.” The radio node 104 can support multiple virtual SSIDs, where each SSID is treated like a vertically isolated virtual Layer 2 domain. Wi-Fi networks that use spectrum in the industrial, scientific, and medical (ISM) bands are generally identified by a “SSID”. SSID is an identifier for the Wi-Fi Network that is displayed to the user who wants to connect to a Wi-Fi network. Newer Wi-Fi standards allow the Access Points to broadcast many SSIDs that actually share the same Radio/channel. While the users think that they are connecting to separate SSIDs, these (virtual) SSIDs are actually using the same spectrum/RF resources. This allows the Wi-Fi service provider to broadcast many SSIDs where each SSID represents a certain service. However, these SSIDs share the same available physical resources. Therefore virtual SSIDs can be used to provide service isolation.

The techniques described herein allow the service provider to virtually slice every virtual local area network (VLAN)/SSID as an independent and isolated Layer 2 domain. The techniques described herein can support scalable Virtual IP Router (VIPR) functions that can be applied to any isolated Layer 2 domain. This can enable a new class of virtualization that extends from the device to the service provider's services (e.g., cloud services).

Referring to the Layer 2 domain 106, the Layer 2 domain 106 provides Layer 2 data connections between the Wi-Fi devices 108 (via the radio nodes 104) and the WAG 102. In the seven-layer OSI model of computer networking, Layer 2 is often referred to as the data link layer. In the transmission control protocol/Internet protocol (TCP/IP) reference model, Layer 2 is often referred to as being part of the link layer. The Layer 2 domain 106 implements a Layer 2 protocol to transfer data between the radio nodes 104 and the WAG 102.

Referring to Wi-Fi device 108, a Wi-Fi device 108 can include any type of device that supports WiFi, such as laptops, desktops, smartphones, tablets, gaming consoles, embedded household appliances (e.g., TVs, thermostats), and/or other devices that support Wi-Fi.

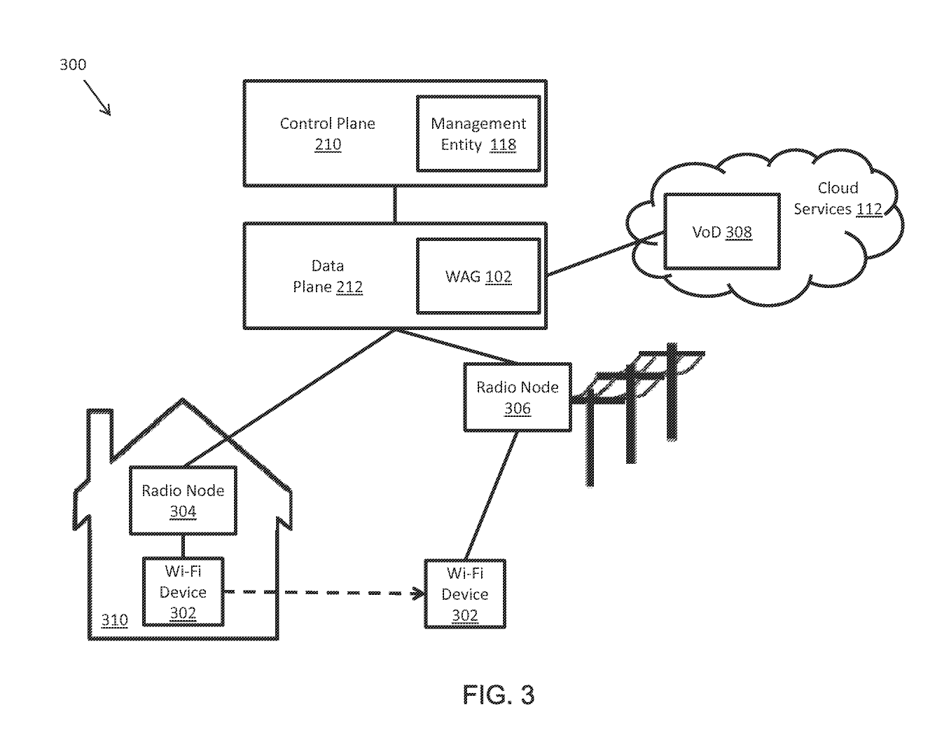

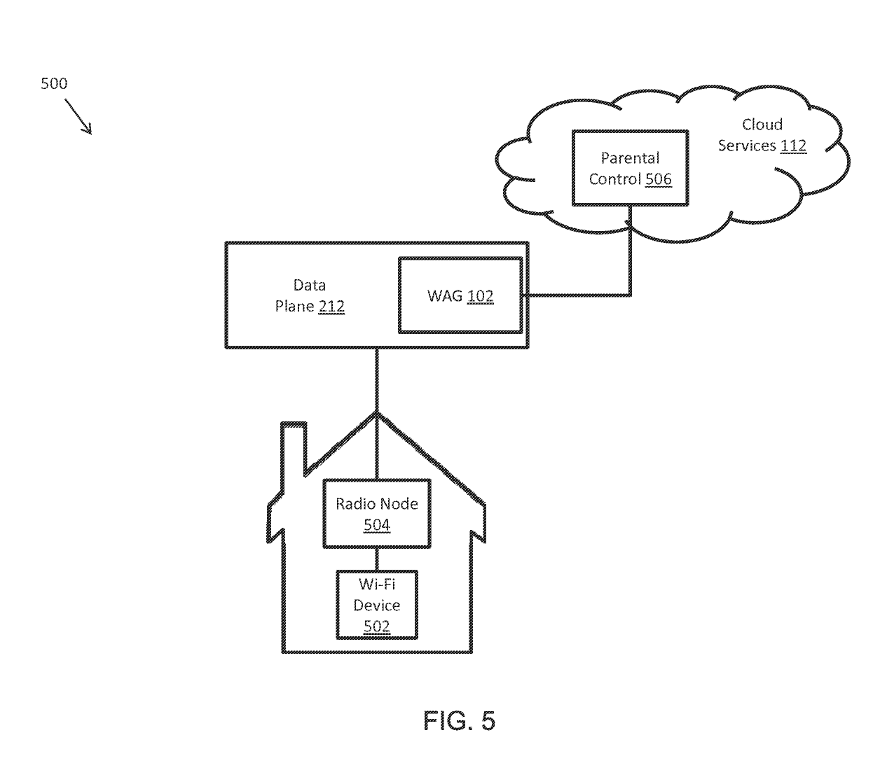

Referring to cloud services 112, the services can include, for example, cloud IP services. For example, cloud services 112 can include services that provide for sharing of digital media between multimedia devices. For example, the Digital Living Network Alliance (DLNA) provides guidelines for digital media sharing that specify a set of restricted ways of using the standards to achieve interoperability. The cloud services 112 can include video on demand services, as explained further herein with reference to FIG. 3. The cloud services 112 can include parental management controls, as explained further herein with reference to FIG. 5.

Traditional connected home technologies (e.g., such as Universal Plug and Play (UPnP) and Digital Living Networks Alliance (DLNA)) are often limited to spatial locality due to existing LAN-based technology. The techniques described herein remove this LAN limitation, enabling wide area implementation of DLNA and UPnP. Virtual wide area multicast/broadcast domains provided using the techniques described herein can let media servers and content servers in the cloud present themselves in the home WLAN. At present, it is estimated that there are thousands of UPnP/DLNA certified devices, and billions of devices installed worldwide. By extending UPnP/DLNA from a LAN to a Wide Area LAN using the techniques described herein, service providers can leverage a cloud SDN architecture to provide services, connectivity, mobility, and/or the like.

Referring to the management entity 118, as described above with respect to the WAG 102, the management entity 118 can include a processor configured to implement the functionality described herein using computer executable instructions stored in temporary and/or permanent non-transitory memory. In some embodiments the management entity 118 is a cloud-based platform leveraging open compute application program interfaces (APIs) to the radio nodes 104 and the WAG 102. For example, the management entity 118 can implement the SDN control plane, management plane, device management, and/or the like. For example, Technical Report 069 (TR-069) is a Broadband Forum technical specification entitled Customer-Premises Equipment Wide Area Network Management Protocol (CWMP) that defines an application payer protocol for remote management of end-user devices. The management entity 118 can use a TR-069-based plug and play management interface to implement the management plane. In some embodiments, the management entity 118 provides network-wide global service and policy control of service provider Wi-Fi services and device connectivity. In some embodiments, the WAG 102 includes a SDN controller (not shown) to manage Layer 2 forwarding information bases (FIBs) in the Wi-Fi radio nodes 104. In some embodiments, the management entity 118 provides a SDN controller to manage Layer 2 FIBs in the Wi-Fi Radio Nodes for policy-based local switching. In some embodiments, the management entity 118 provides scalable resource management of the radio nodes 104. The management entity 118 can also provide flexible integration of operations and business systems (e.g., to monetize Wi-Fi).

Referring to the access controller 116, as described above with respect to the WAG 102, the access controller 116 can include a processor configured to implement the functionality described herein using computer executable instructions stored in temporary and/or permanent non-transitory memory. In some embodiments the access controller 116 provides a highly scalable IP control plane to the radio nodes 104 that can be scaled linearly on demand. In traditional hardware based “box” centric architectures, the scale is typically constant whether one needs less performance or more. However, using the techniques described herein, the control plane is software-based and can therefore be scaled “on demand” linearly (e.g., as opposed to “box” based steps with hardware based silo boxes) by adding more and more generic compute/blade servers on demand. The access controller 116 can use a custom or publicly-defined protocol to manage the radio nodes. The access controller 116 can be a WLAN Access Controller (AC). The access controller 116 can terminate the WLAN control plane to apply opportunistic WLAN RRM Self Organizing Network (SON) capabilities, e.g., in dense WLAN deployments. By separating the user device traffic plane (e.g., terminated at the WAG 102) and the control plane (e.g., terminated at the access controller 116), the techniques described herein can allow the access controller 116 to scale for compute intensive tasks of RRM, as necessary. For example, since the two planes are separated, the access controller 116 may not be limited by user device traffic plane throughput.

As an illustrative example, the distribution of functions between radio nodes 104, the access controller 116, and the WAG 102 can be distributed as described below. The radio nodes 104 can be configured to provide: beacon generation; probe response/transmission; real-time control frames (e.g., RTS/CTS/ACK/PS-Poll/CF-End/CF-Ack); synchronization; retransmission; and 802.11 encryption/decryption (e.g., of MAC service data units, or MSDUs). The radio nodes 104 and the WAG 102 can be configured to provide transmission rate adaption (e.g., the WAG 102 can provide differentiated services code point (DSCP) marking); MSDU Integration Service (e.g., bridging 802.11 to 802.3) such as GRE; and device user plane quality of service (QoS) (e.g., the radio nodes 104 can provide QoS over the air, while the WAG 102 can provide QoS such as traffic shaping and DSCP marking). The access controller 116 can provide device association/disassociation/re-association; transmit power/channel bandwidth/channel assignment/antenna parameters/load balancing (SON); and radio node 104 automatic configuration and management. The WAG 102 can provide MSDU Distribution Service (e.g., intra-system user traffic/mobility); subscriber services (e.g., DHCP) and Internet gateway services; and device policy, billing and charging.

The components of system 100 can include additional interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols, some of which may be non-transient.

While the techniques described herein describe in some embodiments using the techniques over a set of radio nodes in communication with a WAG, one of skill in the art can appreciate that the resulting network created can include a single network or combination of networks. For example, the network can include a local area network (LAN), a cellular network, a telephone network, a computer network, a private packet switching network, a line switching network, a wide area network (WAN), and/or any number of networks. Such networks may be implemented with any number of hardware and software components, transmission media and network protocols. FIG. 1 shows the WAG 102 creating a single Layer 2 domain 106 among the wired devices 110 and the wireless devices 112; however, the network can include multiple interconnected networks listed above.

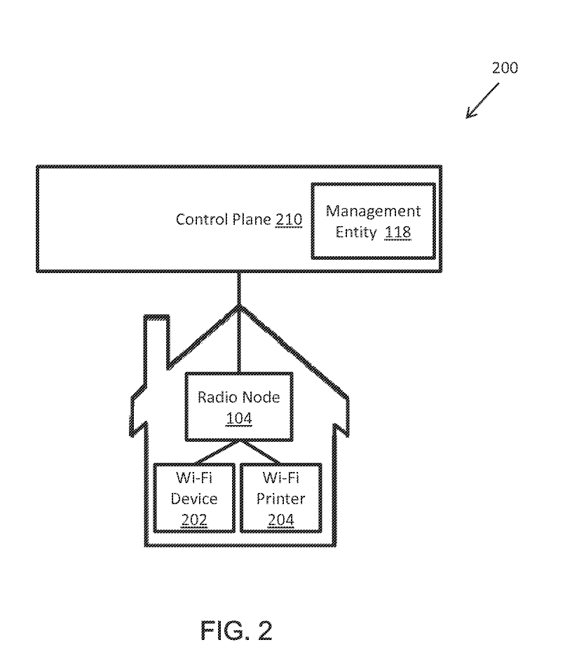

FIG. 2 illustrates an example 200 of a Wi-Fi device 202 printing to a local Wi-Fi printer 204 using centrally managed Wi-Fi, according to some embodiments. The radio node 104 can switch the session between the Wi-Fi device 202 and the Wi-Fi printer 204 locally via a FIB in the radio node 104. For example, the management entity 118 can provide initial or default parameters for the FIB. The WAG 102 can include a controller function that recognizes the two Wi-Fi devices 202 and 204 are both local to the radio node 104, and therefore controls the radio node 104 via the control plane 210 so that the radio node 104 switches communications between the two devices locally rather than switching through the WAG 102. In some embodiments, the protocol the management entity 118 uses to control the FIB in the radio node 104 is OpenFlow. With OpenFlow the WAG 102 controls the radio node 104 FIB table entries.

In some embodiments, the WAG 102 provides Ethernet mobility so that a Wi-Fi device can move among various radio nodes 104 and maintain a Wi-Fi connection. For example, the WAG 102 can use MAC learning and MAC attachment of devices to the Wi-Fi radio nodes 104 to maintain Wi-Fi for mobile devices. For example, as described above the radio nodes are Wi-Fi radio nodes, so a Wi-Fi device attaches to a radio node using its MAC address. Since the WAG has a virtual Layer 2 connection with the radio node (e.g., via Layer 2 data encapsulated in Ethernet frames), the WAG starts seeing data frames coming from the Wi-Fi device from the radio node with the Wi-Fi device's MAC address. In some embodiments, for the first frame the WAG sees with the Wi-Fi device MAC address, the WAG associates the Wi-Fi device with the radio node. As users are walking around the device attaches to a radio node, for example, the WAG can update the device's attachment to a new radio node when it sees data frames from the device coming from different radio nodes. FIG. 3 illustrates an example 300 of a Wi-Fi device 302 moving from radio node 304 to a different radio node 306 using centrally managed Wi-Fi, according to some embodiments. The Wi-Fi device 302 is streaming a session from a service provider's video on demand (VoD) service through the data plane 212 to the radio node 304 in the home 310.

When the Wi-Fi device 302 moves to outdoor Wi-Fi coverage using the radio node 306, the management entity 118 maintains the Wi-Fi device 302's session with the VoD 308 through the data plane 212. The management entity 118 can provide DLNA interworking from the VoD 308 to the Wi-Fi device 302 via the control plane 210, extending DLNA to the data plane 212. Other approaches, such as layer three approaches, often have a much more complex control plane and thus slower handover latency. DLNA can use IP Multicast (UPnP) for content discovery. Since IP Multicast is a local area network technology, DLNA service is limited to a Layer 2 broadcast domain only (e.g. limited to a house or a branch office). By creating wide area Layer 2 virtual network using point-to-point L2 tunnels/overlays based on softGRE, IP Broadcast/Multicast services can work transparently over a wide area. As an example, a user could be traveling and still connect to their DLNA-enabled Blue-Ray DVD player and watch content from a hotel (e.g., just as if the user is at home).

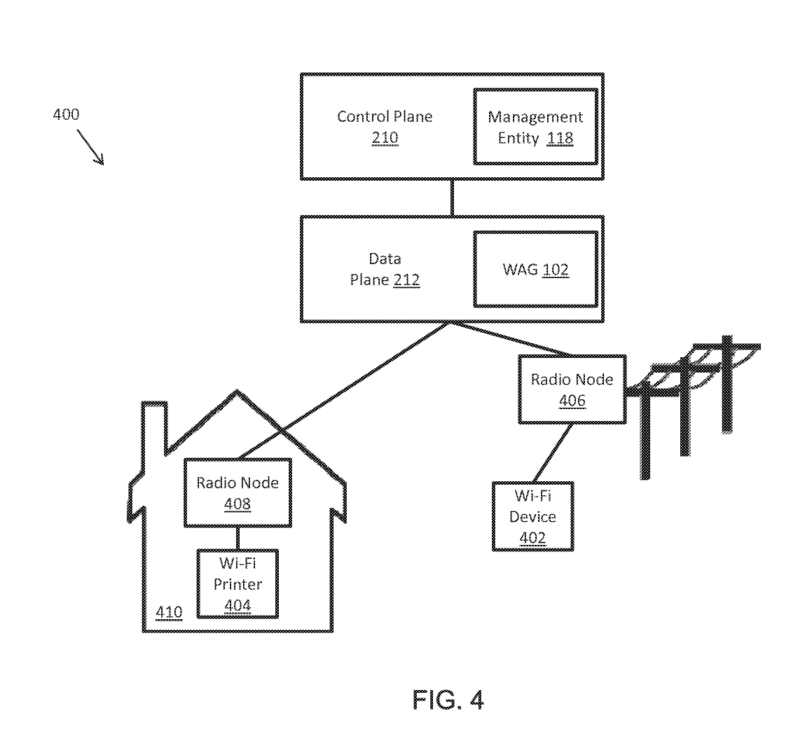

FIG. 4 illustrates an example of a Wi-Fi device 402 in communication with radio node 406 printing to a Wi-Fi printer 404 supported by a different radio node 408 using centrally managed Wi-Fi, according to some embodiments. The Wi-Fi device 402 is connected to the radio node 406 providing outdoor Wi-Fi. The user of the Wi-Fi device 402 wants to print remotely to the home network provided by the radio node 408 for the user's home 410. The WAG 102 provides simplified access via the data plane 212, and the management entity 118 provides a global policy control to establish connectivity and mobility between the Wi-Fi device 402 and the Wi-Fi printer 404. Native Multicast/Broadcast protocols like mDNS, Bonjour, NetBios, SMB2, etc. for home networking work transparently. In this example shown in FIG. 4, Bonjour can be used by printers for printer discovery and printing.

FIG. 5 illustrates an example 500 of parental control of a Wi-Fi device 502 using centrally managed Wi-Fi, according to some embodiments. A user (e.g., a child) is using Wi-Fi device 502, which has been configured using a parental control service so that the device can only access a special SSID where content filtering is performed using cloud-based parental control server 506. The parental control server 506 is coupled to the radio node 504 via the data plane 212, and the radio node 504 steers all flows from the Wi-Fi device 502 to the parental control server 506. The centrally managed Wi-Fi allows the parental control service provider to enable a large number of user devices to use the parental control service provided by the parental control server 506, cost-effectively and quickly. By creating virtual Layer 2 networks, customer devices connect to the core network at Layer 2. Hence such devices can be transparently switched/bridged to application servers like parental control or content filtering servers using softGRE Layer 2 service tunnels. Alternative approaches instead often rely on installing special clients or applications for each device, and/or rely on intelligence in the Horne Gateway. These alternatives add cost and complexity compared to the techniques described herein.

Current end-to-end IP based wireless architectures rely on Mobile IP or Proxy Mobile IP to manage Wi-Fi device mobility. For a low speed walk test (e.g. a walking speed in a metropolitan area), Mobile IP is relatively efficient for macro cellular mobile broadband networks where ranges between cells are in the order of a few miles. At walking speeds, for example, an average mobility event occurs once per 30 minutes. Considering a mobile IP (L3) handover delay of the order of a second, such an average mobility event is acceptable.

However, in small cell/Wi-Fi systems, the cell sizes are in the order of 50 yards or less compared to miles as with macro cellular networks. Even at walking speeds, devices can trigger inter-AP mobility events every 10 seconds or less. Therefore, trying to adapt Mobile IP or Proxy Mobile IP to small cell/Wi-Fi systems becomes exponentially inefficient with increased frequency of handovers, leading to a suboptimal user experience.

This occurs because Mobile IP uses encapsulations and a number of different message exchanges, such as binding update exchanges, etc. Such encapsulations can also increase processing and signaling loads. The techniques described herein, on the other hand, do not rely on any IP messaging, while providing fast handovers (e.g., in less than a hundred ms). Since the devices connect to the WAG using virtual Layer 2 tunnels (e.g., Layer 2 data routed via IP connections), when the device moves from one radio node to another, the WAG learns about this mobility by looking at the source MAC address of the Ethernet frames and matching them to the Layer 2 tunnel of the radio node. The WAG then updates the location of the device as being bound to the new radio node and directs all the traffic towards the new radio node where the device has moved to.

For example, rather than perform IP address allocation, the techniques described herein use MAC learning and MAC attachment to maintain Wi-Fi connections. Additionally, mobility encapsulation is not needed because the WAG keeps a binding of device and radio nodes the device is known to be (or have been) attached to. As the device moves from one radio node to another, the WAG updates the bindings accordingly based on MAC learning. The techniques use a signaling procedure called MAC learning (e.g., matching the device MAC to the MAC of the radio node). Such a procedure does not require additional messaging.

The techniques described herein provide a scalable architecture for service provider applications. Since the Wi-Fi is centrally managed by one or more Wi-Fi access gateways, service providers can roll out new value-added services to all of its Wi-Fi clients. Network-based control of the architecture enables a common security framework for all managed Wi-Fi devices. For example, a Wi-Fi access gateway can update new threat vectors and/or reconfigure firewalls of the radio nodes rather than needing to independently manage or reconfigure each radio node.

Moving the complexity of the Wi-Fi access layer to the network (e.g., rather than at the individual radio nodes) can create high availability. For example, since service providers often have redundant data centers, the Layer 2 access layer is simple enough that it seldom fails, and the Wi-Fi access gateway can support full geographic redundancy. The simplification the Wi-Fi radio nodes as described herein facilitates remote configuration management and upgrades. The architecture can enable over subscription and efficient use of pooled resources in an elastic way for control plane and data plane shared across all the Wi-Fi radio nodes. Additionally, network-based service control enables a third party developer ecosystem leveraging a rich API suite. For example, service providers can create a healthy ecosystem of application developers for niche value-added services.

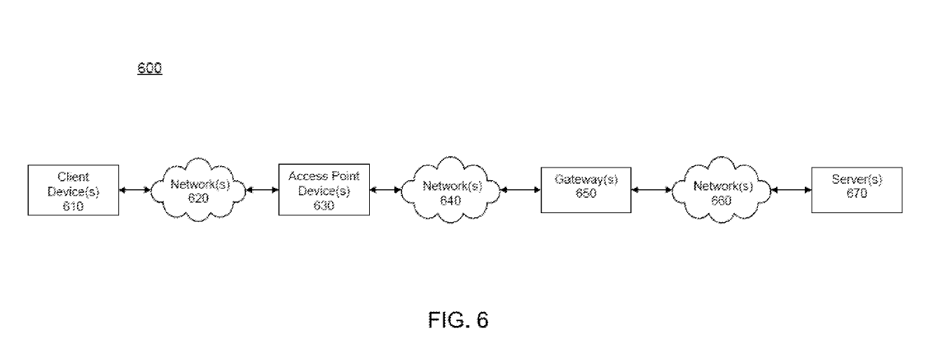

FIG. 6 is a block diagram of an example computing environment 600 for implementing embodiments of the present disclosure. The arrangement and number of components in computing environment 600 is provided for purposes of illustration. Additional arrangements, number of components, and other modifications may be made, consistent with the present disclosure. In some embodiments, computing environment 600 may correspond to, and be another way of representing, system 100 of FIG. 1.

As shown in FIG. 6, computing environment 600 may include one or more client devices 610, networks 620, 640, 660, access point devices 630, gateways 650, and servers 670. Client devices 610 may be coupled to access point device(s) 630, gateway(s) 650, and server(s) 670 by one or more networks 620, 640, 660.

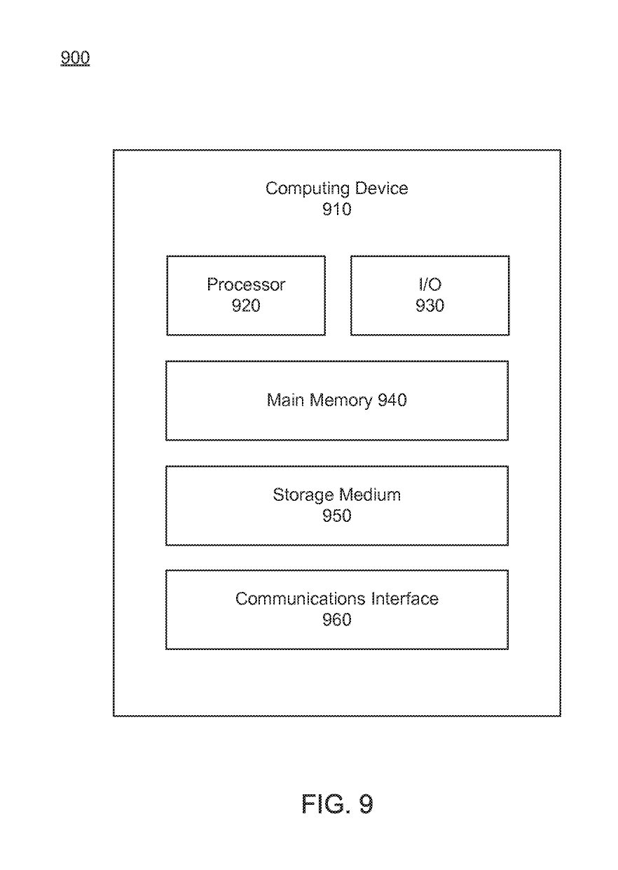

By way of example, a client device 610 could be a personal computer, desktop computer, laptop computer, server, mobile computer, mobile phone, smart phone, tablet computer, netbook, electronic reader, personal digital assistant (PDA), wearable computer, smart watch, gaming device, set-top box, television, personal organizer, portable electronic device, smart appliance, navigation device, and/or other type of computing device. In some embodiments, a client device 610 could be a Wi-Fi device, such as one of Wi-Fi devices 108A-N described above and illustrated in FIG. 1. In some embodiments, a client device 610 may be implemented with hardware devices and/or software applications running thereon. A client device 610 may communicate with one or more computer systems (e.g., access point device(s) 630, gateway(s) 650, server(s) 670) over one or more networks 620, 640, 660. A client device 610 may store browser software that enables client device 610 to access resources on a network, such as the Internet, and DHCP client software that enables client device 610 to receive an IP address over DHCP protocol. In some embodiments, one or more of client device(s) 610 may be implemented using a computer system, such as computer system 900 of FIG. 9.

Computing environment 600 may include one or more networks 620. In one embodiment, network(s) 620 may be one or more local networks (e.g., personal area networks (PANs), local area networks (LANs), metropolitan area networks (MANs)), though the disclosure is not so limited. Network(s) 620 may connect client device(s) 610 with one or more access point devices 630, gateways 650, servers 670, and/or other client devices 610. Network(s) 620 may include one or more PANs, LANs, MANs, wide area networks (WANs), or any combination of these networks. Network(s) 620 may include a combination of a variety of different network types, including Ethernet, intranet, twisted-pair, coaxial cable, fiber optic, cellular, satellite, IEEE 802.11, Wi-Fi, terrestrial, Internet, and/or other types of wired or wireless networks. In some embodiments, network(s) 620 may be one or more networks connecting one or more Wi-Fi devices (e.g., one or more of Wi-Fi devices 108A-N) with one or more radio nodes (e.g., one or more of radio nodes 104A-N).

Client device(s) 610, gateway(s) 650, and/or server(s) 670 may be configured to communicate with one or more access point devices 630 through one or more networks 620. An access point device 630 may be a home gateway (HGW), router, bridge, or other type of device that may relay messages onto different networks, or different links of a network. In some embodiments, an access point device 630 may be a radio node, such as one of radio nodes 104A-N described above and illustrated in FIG. 1. In some embodiments, an access point device 630 may append information, such as data identifying a location or subnet of a network on which the access point device is located, before relaying the message to other network devices. An access point device 630 may be any type of device for relaying network message, and may exist as software, hardware, or a combination of software and hardware. In some embodiments, an access point device 630 may broadcast service set identifiers (SSIDs) of IEEE 802.11 networks that are available for connection by wireless devices. In some embodiments, one or more access point devices 630 may be implemented using a computer system, such as computer system 900 of FIG. 9.

Computing environment 600 may also include one or more networks 640. In one embodiment, network(s) 640 may be one or more local area networks (e.g., personal area networks (PANs), local area networks (LANs), metropolitan area networks (MANs), though the disclosure is not so limited. Network(s) 640 may connect gateway(s) 650 and/or access point device(s) 630 with one or more client devices 610, servers 670, other access point devices 630, and/or other gateways 650. Network(s) 640 may include one or more PANs, LANs, MANs, wide area networks (WANs), or any combination of these networks. Network(s) 640 may include a combination of a variety of different network types, including Ethernet, intranet, twisted-pair, coaxial cable, fiber optic, cellular, satellite, IEEE 802.11, Wi-Fi, terrestrial, Internet, and/or other types of wired or wireless networks. In some embodiments, network(s) 640 may be one or more networks connecting one or more radio nodes (e.g., one or more of radio nodes 104A-N) with one or more Wi-Fi access gateways 102 and/or access controllers 116. In some embodiments, network(s) 640 may be a layer 2 domain, such as layer 2 domain 106 described above and illustrated in FIG. 1. In some embodiments, network(s) 640 may include a cable modem termination system (CMTS) (not shown), through which a layer 2 tunnel using softGRE is established between an access point 630 an a gateway 650.

Client device(s) 610, access point device(s) 630, and/or server(s) 670 may be configured to communicate with one or more gateways 650 through one or more networks 620, 640, 660. A gateway 650 may control incoming and outgoing network traffic based on pre-established rules, convert messages between different network protocols, store information about client devices 610 on a network, store information about network configuration parameters, and/or store one or more policies associated with one or more networks of network(s) 620, 640, 660. In some embodiments, a gateway 650 may receive one or more policies associated with networks from a server 670, such as a authentication, authorization, and accounting (AAA) server (e.g., a Remote Authentication Dial In User Service (RADIUS) server, a Diameter server, a terminal access controller access-control system (TACACS) server) and/or a policy and charging rules function (PCRF) server. For example, the policies may be received from a server 670 on a regular basis, periodically, or when software updates are available. In some embodiments, a gateway 650 may be configured to carry out certain functionality of an AAA server, such as authentication and/or authorization functionality. A gateway 650 may be a standalone computing system or apparatus, or it may be part of a larger system. For example, gateway(s) 650 may represent distributed gateways that are remotely located and communicate over a communication network, or over a dedicated network, such as a LAN. Gateway(s) 650 may include one or more back-end servers for carrying out one or more aspects of the present disclosure.

A gateway 650 may be implemented as a server system comprising a plurality of servers, or a server farm comprising a load balancing system and a plurality of servers. A gateway 650 may be any type of known gateway, such as a wireless access gateway (WAG) or Wi-Fi gateway, and may include any type of known authentication and/or authorization server, such as an AAA server. A gateway 650 may exist as software, hardware, or a combination of software and hardware. In some embodiments, one or more gateways 650 may be a Wi-Fi access gateway, such as Wi-Fi access gateway 102 described above and illustrated in FIG. 1. In some embodiments, one or more gateways 650 may include access controller 116 and/or management entity 118. In some embodiments one or more gateways 650 may include a hierarchical quality of service (H-QoS) shaper. In some embodiments, one or more gateways 650 may be implemented using a computer system, such as computer system 900 of FIG. 9.

Computing environment 600 may also include one or more networks 660. In one embodiment, network(s) 660 may be one or more local networks (e.g., personal area networks (PANs), local area networks (LANs), metropolitan area networks (MANs)), though the disclosure is not so limited. Network(s) 660 may connect server(s) 670 with one or more, gateways 650, access point devices 630, client devices 610, and/or other servers 670. Network(s) 660 may include one or more PANs, LANs, MANs, wide area networks (WANs), or any combination of these networks. Network(s) 660 may include a combination of a variety of different network types, including Ethernet, intranet, twisted-pair, coaxial cable, fiber optic, cellular, satellite, IEEE 802.11, Wi-Fi, terrestrial, Internet, and/or other types of wired or wireless networks.

Client device(s) 310, access point device(s) 630, and/or gateway(s) 670 may be configured to communicate with one or more servers 670. A server 670 may be a network solution for controlling incoming and outgoing network traffic based on pre-established rules, and may store policies provisioned by a network administrator or user to accept or deny certain devices onto a network. In some embodiments, server 670 may be an authentication, authorization, and accounting (AAA) server, such as a Remote Authentication Dial In User Service (RADIUS) server, a Terminal Access Controller Access-Control System (TACACS) server, or a policy and charging rules function (PCRF) server. A server 670 may store rules and/or policies for authorizing and/or authenticating client devices 610 onto a network (e.g., one of networks 620, 640, 660), and/or may store information identifying client devices 610 (e.g., MAC addresses, device names, user names, domain names, device addresses, device locations, device types). A server 670 may be a standalone computer system or apparatus, or it may be part of a larger system. For example, server(s) 670 may represent distributed servers that are remotely located and communicate over a communications network, such as a LAN. Server(s) 670 may include one or more back-end servers for carrying out one or more aspects of the present disclosure.

A server 670 may be implemented as a server system comprising a plurality of servers, or a server farm comprising a load balancing system and a plurality of servers. A server 670 may be any type of known server, and may exist as software, hardware, or a combination of software and hardware. In some embodiments, a server 670 may be an access controller, such as access controller 116 described above and illustrated in FIG. 1, and/or a management entity, such as management entity 118 described above and illustrated in FIG. 1. In some embodiments, one or more servers 670 may be implemented using a computer system, such as computer system 900 of FIG. 9.

Although computing environment 600 of FIG. 6 illustrates separate client device(s) 610, access point device(s) 630, gateway(s) 650, and server(s) 670, the disclosure is not so limited. Any of access point device(s) 630, gateway(s) 650, and/or server(s) 670 could be implemented together on the same computer system, such as on computer system 900 of FIG. 9. As one example, access point device(s) 630, gateway(s) 650, and server(s) 670 could all exist on the same computer system, such as on a computer system 900 of FIG. 9. Moreover, in some embodiments, computing environment 600 may not include access point device(s) 630. Rather, messages from a client device 610 may be sent directly to a gateway 650, and messages from a gateway 650 may be sent directly to a client device 610.

Although computing environment 600 of FIG. 6 illustrates separate network(s) 620, 640, 660, the disclosure is not so limited. For example, embodiments of the present disclosure may be implemented in computing environments utilizing only one or two networks, which may include only local network(s) and/or wide area network(s).

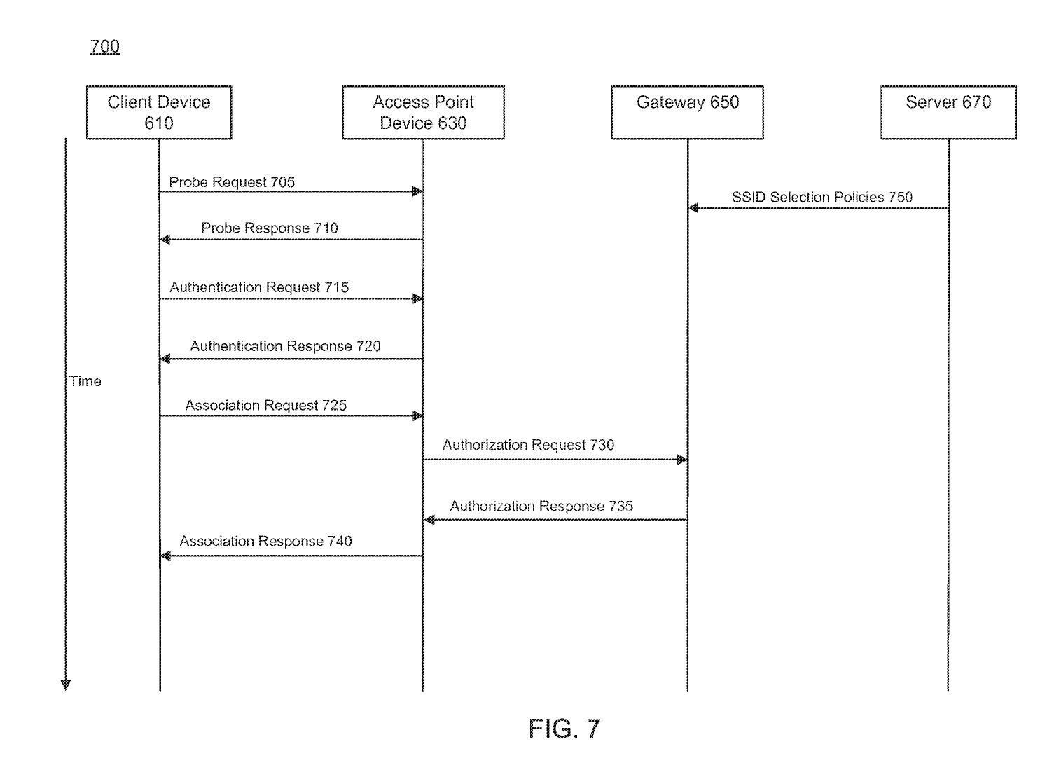

FIG. 7 illustrates a diagram 700 of example messages transmitted over time in managing access of a wireless device to a network, such as a Wi-Fi or IEEE 802.11 network, based on one or more policies, consistent with embodiments of the present disclosure. A client device 610 may send a probe request message 705 to an access point device 630. Client device(s) 610 may send probe request messages to discover IEEE 802.11 networks within proximity of client device(s) 610. In some embodiments, probe request message 705 may advertise the supported data rates and IEEE 802.11 capabilities of a client device 610 sending the request. An AP 630 may receive the probe request message 705. The AP may then send a probe response message 710 advertising one or more SSIDs (e.g., wireless network names). In some embodiments, the AP may only advertise SSIDs with which the client device 610 has a compatible data rate. In some embodiments, the probe response message may indicate supported data rates of the SSID, encryption types employed in the SSID, and other capabilities of the AP.

The client device that sent the probe request message 705 may then receive the probe response message 710. In some embodiments, the client device may receive probe response messages 710 from a plurality of APs, since all APs that receive the probe request message 705 may send probe response messages 710. The client device may then select one of the SSIDs with which it would like to associate. The client device may do so automatically based on selection rules stored at the client device, or a user of the client device may select the SSID to which he/she would like the client device to connect.

Once a SSID has been selected, an authentication request message 715 is sent from the client device to the AP. The AP may receive the authentication request message and may send an authentication response message 720 to the client device 610. If the authentication response message 720 indicates that authentication was successful, the client device may send an association request message 725 to the AP. Once association request message 725 is received by the AP, the AP may send an authorization request message 730 to one or more gateways 650 to determine whether the client device is authorized to associate with the SSID. In some embodiments, authorization request message 730 may be a RADIUS request message (e.g., a RADIUS Access-Request message) or a TACACS request message. In some embodiments, authorization request message 730 may include information from association request message 725. In some embodiments, the information may be indicative of one or more of the SSID of the wireless network to which the client device is requesting association, the basic service set identifier (BSSID) of the wireless network to which the client device is requesting association, a type of the wireless network to which the client device is requesting association, a type of the wireless device, a location of the wireless device, an application of the wireless device that caused the authorization request message to be generated, a time at which the authorization request message or association request message was generated, a type of subscriber associated with the wireless device, a user name associated with a user of the device, a password associated with the user of the device, or other information associated with the device or a user of the device.

Once gateway 650 has received authorization request message 730, it may retrieve one or more policies associated with the network to which the client device is requesting association. The policies may be stored locally on a storage device of gateway 650, or may be retrieved from a server 670 over a network. In some embodiments, the policies may be received (e.g., SSID selection policies 750) from a server 670. The policies may be received on a regular basis, periodically, intermittently, when available, or when software updates are available. The policies may be created by one or more operators, network administrators, users, or subscribers of the service provider. Gateway 650 may store the received policies in a storage device. The one or more policies may be associated with the requested network by network identifier (e.g., BSSID or SSID), or by network type. Each of the one or more policies may include one or more conditions that must be satisfied in order for association between the client device and the network to be granted. In some embodiments, a condition may specify a certain piece of the information in the authorization request message that would allow the association to be authorized. For example, the condition may correspond to a list of types of devices which are allowed to associate with the network. If the type of the client device requesting association appears on the list, association between the client device and network may be allowed. In some embodiments, a condition may specify a certain piece of the information in the authorization request message that would prevent the association from being authorized. For example, the condition may correspond to a list of types of devices which are not allowed to associate with the network. If the type of the client device requesting association appears on the list, association between the client device and the network would not be allowed. In some embodiments, a combination of different conditions may be employed. In some further embodiments, conditions may be chained together. For example, a client device may be denied association with a particular network if it is a certain type of device, such as a gaming device, or if it is in a certain location, such as connected to a certain AP.

Gateway 650 may determine whether the one or more conditions associated with the network are satisfied based at least in part on the information in the authorization request message. If the conditions are satisfied, gateway 650 may send an authorization response message 735 (e.g., a RADIUS Access-Accept message) to AP 630 indicating that authorization to associate client device 610 with the requested network has been granted. If at least one of the conditions is not satisfied, gateway 650 may send an authorization response message 735 (e.g., a RADIUS Access-Reject message) to AP 630 indicating that authorization to associate client device 610 with the requested network has been denied.

Once AP 630 receives authorization response message 735, AP 630 may send an association response message 740 to client device 610 indicating whether the association has been granted or denied. For example, if authorization response message 735 indicates that authorization to associate the client device with the requested network has been denied, AP 630 may send an association response message 740 to the client device indicating that the association has been denied. If authorization response message 735 indicates that authorization to associate the client device with the requested network has been granted, AP 630 may send an association response message 740 to the client device indicating that the association has been granted. In some embodiments, the association response message 740 may cause a prompt to be displayed on a display of the wireless device indicating that the association with the network failed. In some embodiments, when gateway 650 denies authorization to associate the client device with the network, gateway 650 may provide a recommended network in the authorization message 735. The recommended network may be recommended based on the information received in the authorization request message 730. For example, if the information indicates that the device is connected to an AP associated with a user of the device, such as a home gateway, gateway 650 may recommend that the device connect to a private network. AP 630 may be configured to send an association response message 740 in response to such an authorization request message 730. The association response message may cause a prompt to be displayed on a display of the client device indicating that another network has been recommended. Alternatively, the association response message may cause the client device to automatically attempt to associate with the recommended network.

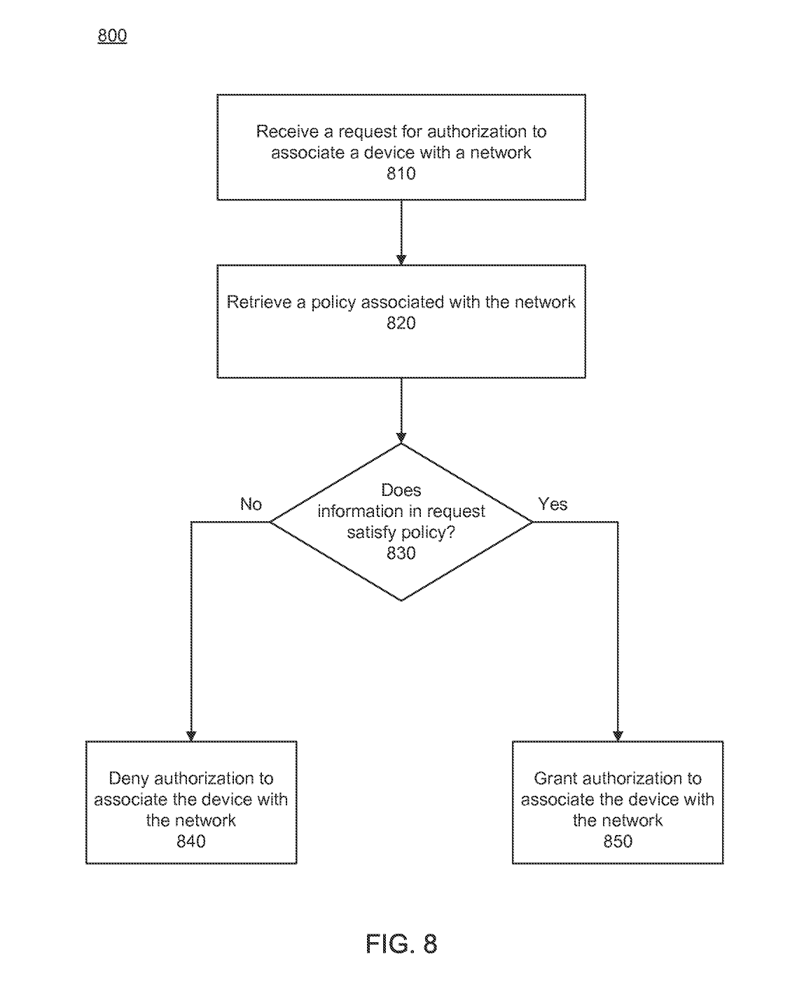

FIG. 8 illustrates a flowchart of an example method 800 for managing access of a wireless device to a network based on one or more policies, consistent with embodiments of the present disclosure. Example method 800 may be implemented in a computing environment (see, e.g., FIG. 6) using one or more computer systems (see, e.g., FIG. 9). In some embodiments, method 800 may be performed by one or more gateways 650, by one or more access points 630, by one or more servers 670, of any combination of the above.

In step 810, a message requesting authorization to associate a client device, such as a client device 610, with a network may be received. The message may be, for example, an authorization request message, such as a RADIUS authorization request message, or a TACACS authorization request message. In some embodiments, the authorization request message may include information indicative of one or more of a SSID of the wireless network to which the client device is requesting association, a basic service set identifier (BSSID) of the wireless network to which the client device is requesting association, a type of the wireless network to which the client device is requesting association, a type of the wireless device, a location of the wireless device, an application of the wireless device that caused the authorization request message to be generated, a time at which the authorization request message or association message was generated, a type of subscriber associated with the wireless device, a user name associated with a user of the device, a password associated with the user of the device, or other information associated with the device or a user of the device.

In step 820, one or more policies associated with the requested network, or with a type of network corresponding to the requested network, may be retrieved. Each of the retrieved policies may include one or more conditions that must be satisfied in order to grant authorization to associate the client device with the network. For example, for a policy associated with a public network, a condition may specify that wireless devices that are a certain type of device, such as gaming devices, will be denied authorization to associate with the public network. Policies may include conditions related to, for example, type of client device, type of application that caused the request for authorizing the association with the network to be generated, location of the client device, time of day, type of subscriber associated with the client device, level of network congestion, and number of devices from a user associated with the client device which are associated with the network. In some embodiments, conditions and/or policies may be chained. For example, five different conditions could be chained such that, if any of the five conditions is not met, authorization to associate the client device with the network will be denied. As another example, five different conditions could be chained such that, authorization will be granted unless all of the five conditions are met.

In step 830, method 800 may determine whether information in the authorization request message satisfies the one or more conditions in the policy. For example, information in the authorization request message may include any one or more of a username, password, client device type, application type, application identifier, subnet identifier, time, subscriber type, or any other information. If the policy includes a condition that depends on a type of the client device, information indicating the type of the client device in the authorization request message may be compared with types of devices listed in the policy. If the type of the client device matches one of the device types listed in the policy, authorization to associate the client device with the network may be granted or denied based on how the policy is configured. Similarly, if a policy includes a condition that depends on a type of application that caused the request to be generated, information indicating the type of application in the authorization request message may be compared with types of applications listed in the policy. If the type of application matches one of the application types listed in the policy, authorization to associate the client device with the network may be granted or denied based on how the policy is configured.

As another example, if the policy includes a condition that depends on a location of the client device, information indicating a subnet to which the client device is connected from the authorization request message may be compared with subnets listed in the policy. If the subnet matches one of the subnets listed in the policy (e.g., a subnet associated with a home of a user of the client device), authorization to associate the client device with the network may be granted or denied based on how the policy is configured. As still another example, if the policy includes a condition that depends on a time, such as a time of day during which the authorization request message or association request message was generated, information indicating the time from the authorization request message may be compared with one or more windows of time listed in the policy. If the time falls within one or more of the windows of time, authorization to associate the client device with the network may be granted or denied based on how the policy is configured.

As another example, if the policy includes a condition that depends on a type of subscriber, information indicating the type of subscriber from the authorization request message may be compared with subscriber types listed in the policy. If the authorization request message does not include a subscriber type, method 800 may look up the subscriber type based on a user name included in the authorization request message. A subscriber type may be a certain class of subscriber (e.g., “gold,” “silver,” “bronze,” “elite”), which may depend on how much the user pays for service from the service provider. If the type of subscriber matches a subscriber type listed in the policy, or falls above or below a subscriber type listed in the policy, authorization to associate the client device with the network may be granted or denied based on how the policy is configured.

As still another example, the policy may include a condition that depends on network congestion. In such a scenario, method 800 may determine a level of congestion on the network. The level of network congestion can be compared with a threshold level listed in the policy. If the level of network congestion is equal to or above the threshold level listed in the policy, authorization to associate the client device with the network may be denied.

As still another example, the policy may include a condition that limits a particular user to a certain number of devices on the network. In such a scenario, method 800 may determine how many devices associated with the user are currently connected to the requested network. If the number of devices connected to the requested network is greater than or equal to a certain threshold number listed in the policy, authorization to associate the client device with the network may be denied.

If all of the conditions in the one or more policies associated with the requested network are satisfied in step 830, method 800 may proceed to step 850, and may grant authorization to associate the device with the network. Step 850 may include, for example, causing an authorization response message to be sent to the AP indicating that authorization to associate the client device with the network has been granted. If any of the conditions in the one or more policies is not satisfied in step 830, method 800 may proceed to step 840, and may deny authorization to associate the device with the network. Step 840 may include, for example, causing an authorization response message to be sent to the AP indicating that authorization to associate the client device with the network has been denied.

FIG. 9 is a block diagram illustrating an example computer system 900 that may be used for implementing embodiments consistent with the present disclosure, including the example systems and methods described herein. Computer system 900 may include one or more computing devices 910. Computer system 900 may be used to implement client device(s) 610, access point device(s) 630, gateway(s) 650, and/or server(s) 670. The arrangement and number of components in computer system 900 is provided for purposes of illustration. Additional arrangements, number of components, or other modifications may be made, consistent with the present disclosure.

As shown in FIG. 9, a computing device 910 may include one or more processors 920 for executing instructions. Processors suitable for the execution of instructions may include, by way of example, both general and special purpose microprocessors, and any one or more processors of any kind of digital computer. A computing device 910 may also include one or more input/output (I/O) devices 930. By way of example, I/O devices 930 may include keys, buttons, mice, joysticks, styluses, etc. Keys and/or buttons may be physical and/or virtual (e.g., provided on a touch screen interface). A computing device 910 may also be connected to one or more displays (not shown) via I/O 930. A display may be implemented using one or more display panels, which may include, for example, one or more cathode ray tube (CRT) displays, liquid crystal displays (LCDs), plasma displays, light emitting diode (LED) displays, touch screen type displays, projector displays (e.g., images projected on a screen or surface, holographic images, etc.), organic light emitting diode (OLED) displays, field emission displays (FEDs), active matrix displays, vacuum fluorescent (VFR) displays, 3-dimensional (3-D) displays, electronic paper (e-ink) displays, or any combination of the above types of displays.

A computing device 910 may include one or more storage devices configured to store data and/or software instructions used by processor(s) 920 to perform operations consistent with disclosed embodiments. For example, a computing device 910 may include main memory 940 configured to store one or more software programs that, when executed by processor(s) 920, cause processor(s) 920 to perform functions or operations consistent with disclosed embodiments.

By way of example, main memory 940 may include NOR and/or NAND flash memory devices, read only memory (ROM) devices, random access memory (RAM) devices, etc. A computing device 910 may also include one or more storage mediums 950. By way of example, storage medium(s) 950 may include hard drives, solid state drives, tape drives, redundant array of independent disks (RAID) arrays, etc. Although FIG. 9 illustrates only one main memory 940 and one storage medium 950, a computing device 910 may include any number of main memories 940 and storage mediums 950. Further, although FIG. 9 illustrates main memory 940 and/or storage medium 950 as part of computing device 910, main memory 940 and/or storage medium 950 may be located remotely and computing device 910 may be able to access main memory 940 and/or storage medium 950 via network(s) 620, 640, 660.

Storage medium(s) 950 may be configured to store data, and may store data received from one or more client device(s) 610, access point device(s) 630, gateway(s) 650, and/or server(s) 670. The data may take or represent various content or information forms, such as documents, tables, lists, IP addresses, MAC addresses, user names, passwords, client device information, security information, software applications, files, and any other type of information and/or content which may be used in network applications, or any combination thereof. In some embodiments storage medium(s) 950 may be configured to store policies for authorizing association between client devices and networks. In some embodiments, the policies may be received from one or more server(s) 670, such as an AAA server, on an intermittent, regular, periodic, or occasional basis.

A computing device 910 may further include one or more communication interfaces 960. Communication interface(s) 960 may allow software and/or data to be transferred between client device(s) 610, access point device(s) 630, gateway(s) 650, and server(s) 670. Examples of communication interface 960 may include a modem, network interface card (e.g., Ethernet card), communications port, personal computer memory card international association (PCMCIA) slots and cards, antennas, etc. Communications interface(s) 960 may transfer software and/or data in the form of signals, which may be electronic, electromagnetic, optical, and/or other types of signals. The signals may be provided to/from communication interface(s) 960 via a communications path (e.g., network(s) 620, 640, 660), which may be implemented using wired, wireless, cable, fiber optic, radio frequency (RF), and/or other communications channels.

The disclosed embodiments are not limited to separate programs or computers configured to perform dedicated tasks. For example, a gateway 650 may include a computing device 910 that includes a main memory 940 that stores a single program or multiple programs and may additionally execute one or more programs located remotely from gateway 650. Similarly, a client device 610, access point device 630, and/or server 670 may execute one or more remotely stored programs instead of, or in addition to, programs stored on these devices. In some examples, a gateway 650 may be capable of accessing separate server(s), gateways, and/or computing devices that generate, maintain, and provide network configuration information, access policies, and/or client device information.

Although the description above has described the use of gateway(s) 650 in the context of managing access of a Wi-Fi device to a Wi-Fi network based on one or more policies, the disclosure is not so limited. One of skill in the art would recognize that a gateway 650 implementing the features and embodiments of the present disclosure may manage access of other types of network-enabled devices to other types networks based on requests from client devices, in a similar manner to that disclosed herein. That is, the features and embodiments disclosed herein are not limited in application to Wi-Fi enabled devices and networks.

The subject matter described herein can be implemented in digital electronic circuitry, or in computer software, firmware, or hardware, including the structural means disclosed in this specification and equivalents thereof, or in combinations of them. The subject matter described herein can be implemented as one or more computer program products, such as one or more programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g, a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g, a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized for designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing example embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computer-implemented method for managing access of a wireless device to a network based on one or more policies, comprising:
receiving, by a computing device including a memory and a processor configured to execute instructions stored in the memory, a request for authorization from an access point to associate a wireless device with a network;
retrieving, by the computing device, a policy associated with the network from a storage device in response to the request;
determining, by the computing device, that information included in the request fails to satisfy a condition in the policy; and
transmitting, by the computing device, a response to the access point denying authorization to associate the wireless device with the network based at least in part on the determination that the information failed to satisfy the condition.

2. The method of claim 1, wherein the request is a first request, the network is a first network, the policy is a first policy, the information is first information, the condition is a first condition, and the response is a first response, further comprising:
receiving, by the computing device, a second request for authorization to associate the wireless device with a second network;
retrieving, by the computing device, a second policy associated with the second network from the storage device in response to the second request;
determining, by the computing device, that second information included in the second request satisfies a second condition in the second policy; and
transmitting, by the computing device, a second response granting authorization to associate the wireless device with the second network based at least in part on the determination that the second information satisfies the second condition.

3. The method of claim 1, wherein the condition of the policy restricts authorization to the network based on at least one of the following:
a type of the wireless device;
a location of the wireless device;
an application of the wireless device that caused the request to be generated;
a time at which the request was generated;
a type of subscriber associated with the wireless device;
a level of congestion on the network;
and a number of devices associated with a user of the wireless device that are associated with the wireless network.

4. The method of claim 1, wherein the information conveys a type of the wireless device, and the determining comprises identifying that the type of the wireless device is not a type that satisfies the condition of the policy.

5. The method of claim 1, wherein the request is generated as a result of a selection of a service set identifier (SSID) of the network at the wireless device.

6. The method of claim 1, wherein the computing device is a gateway, and the gateway includes the storage device.

7. The method of claim 1, wherein the request is a Remote Authentication Dial In User Service (RADIUS) access request message, and the response is a RADIUS response message.

8. The method of claim 1, wherein the policy was received from an authentication, authorization, and accounting (AAA) server.

9. The method of claim 2, wherein the first network is a public network, and the second network is a private network.

10. The method of claim 2, wherein at least one of the first network and the second network is a Wi-Fi network.

11. A computer-implemented system for managing access of a wireless device to a network based on one or more policies, comprising:
one or more memory devices that store instructions; and
one or more processors that execute the instructions to:
receive a request for authorization from an access point to associate a wireless device with a network;
retrieve a policy associated with the network from a storage device in response to the request;
determine that information included in the request fails to satisfy a condition in the policy; and
cause a response to be transmitted to the access point denying authorization to associate the wireless device with the network based at least in part on the determination that the information failed to satisfy the condition.

12. The system of claim 11, wherein the request is a first request, the network is a first network, the policy is a first policy, the information is first information, the condition is a first condition, and the response is a first response, and the one or more processors further execute the instructions to:
receive a second request for authorization to associate the wireless device with a second network;
retrieve a second policy associated with the second network from the storage device in response to the second request;
determine that second information included in the second request satisfies a second condition in the second policy; and
cause a second response to be transmitted granting authorization to associate the wireless device with the second network based at least in part on the determination that the second information satisfies the second condition.

13. The system of claim 11, wherein the condition of the policy restricts authorization to the network based on at least one of the following:
a type of the wireless device;
a location of the wireless device;
an application of the wireless device that caused the request to be generated;
a time at which the request was generated;
a type of subscriber associated with the wireless device;
a level of congestion on the network;
and a number of devices associated with a user of the wireless device that are associated with the wireless network.

14. The system of claim 11, wherein the information conveys a type of the wireless device and the one or more processors further execute the instructions to identify that the type of the wireless device is not a type that satisfies the condition of the policy.

15. The system of claim 11, wherein the request is generated as a result of a selection of a service set identifier (SSID) of the network at the wireless device.

16. The system of claim 11, wherein the request is a Remote Authentication Dial In User Service (RADIUS) access request message, and the response is a RADIUS response message.

17. The system of claim 11, wherein the policy was received from an authentication, authorization, and accounting (AAA) server.

18. The system of claim 12, wherein the first network is a public network, and the second network is a private network.

19. The system of claim 12, wherein at least one of the first network and the second network is a Wi-Fi network.

20. A non-transitory computer-readable medium storing instructions that, when executed by one or more processors, cause the one or more processors to perform a method for managing access of a wireless device to a network based on one or more policies, the method comprising:
receiving a request for authorization from an access point to associate a wireless device with a network;
retrieving a policy associated with the network from a storage device in response to the request;
determining that information included in the request fails to satisfy a condition in the policy; and
causing a response to be transmitted to the access point denying authorization to associate the wireless device with the network in response to the determination that the information failed to satisfy the condition.
